(19) United States
(12) Patent Application Publication
(10) Pub. No.: US 2016/0370040 A1
(43) Pub. Date: Dec. 22, 2016

(54) System Independent Refrigerant Control System

(71) Applicant: SBB Intellectual Property, LLC, East Syracuse, NY (US)

(72) Inventor: Vincent J. Bongio, East Syracuse, NY (US)

(73) Assignee: SBB Intellectual Property, LLC, East Syracuse, NY (US)

(21) Appl. No.: 15/189,480

(22) Filed: Jun. 22, 2016

Related U.S. Application Data
(60) Provisional application No. 62/230,979, filed on Jun. 22, 2015.

(51) Int. Cl. F25B 41/06

(52) U.S. Cl. CPC F25B 41/062; F25B 41/067; F25B 2341/062; F25B 2600/2513; F25B 2700/2117; F16K 31/004

(57) ABSTRACT

The present invention provides a system independent valve used in a refrigeration cycle in place of a typical pressure reducing expansion valve or capillary tube. The system independent valve will regulate saturated liquid flow enroute to the evaporator by introducing a controlled ultrasonic crystal pulse within the valve. The controlled excitation will form pressure waves and vapor pockets that result in vapor sonic velocity at the valve which is variable.

### REFERENCE TO RELATED APPLICATION

The present application relates and claims priority to U.S. Provisional Patent Application Ser. No. 62/230,979, filed Jun. 22, 2015, the entirety of which is hereby incorporated by reference.

### BACKGROUND

1. Field of Invention

The present invention relates to refrigerant flow control in a compression refrigerant cycle, and more particularly to non-fluid communicative, system-independent refrigerant flow control.

2. Background of Art

In a classical, prior art refrigeration Pressure-Enthalpy (P-H) compression cycle, high pressure, high temperature, high enthalpy saturated liquid flows from a liquid receiver through a liquid line to the filter dryer and to an expansion device such as a thermostatic expansion valve (TXV). The function of the expansion device is to reduce the pressure level at the cooling heat exchanger or evaporator. The operation of the TXV is controlled by both the temperature of the TXV control bulb and the pressure in the evaporator. The temperature of the TXV control bulb must be higher than the evaporator refrigerant temperature before the valve will open. The amount of opening will be governed by the temperature of the evaporator. If the evaporator is relatively warm, the TXV needle valve will open wide allowing a rapid flow of liquid refrigerant. This increases cooling rate. As the temperature of the evaporator drops due to the low pressure refrigerant, the TXV needle valve will reduce the flow of refrigerant. Reduction of the liquid pressure causes a release of refrigerant internal energy which is liberated in the form of flash gas, and a controlled reduction to the evaporator temperature level takes place so useful cooling can be accomplished on a product or process.

The refrigerant is vaporized in the evaporator whereby it returns to the compressor and is compressed back to high pressure vaporized refrigerant. As this flows through the condenser, it gives up the heat absorbed in the evaporator now cooled; the refrigerant condenses back into a liquid and flows back to the liquid receiver to complete the cycle.

With the aid of FIG. 1, this typical refrigeration Pressure-Enthalpy (P-H) compression cycle is schematically shown. First, high pressure and high temperature liquid refrigerant at pressure level P1 and enthalpy H4 enters an expansion device. As stated above, the function of the expansion device is to reduce the pressure level from P1 (pressure at condenser or high heat sink level) to P2 (the pressure at the low temperature sink) at the cooling heat exchanger. Reduction of the saturated liquid from P1 to P2 causes a release of refrigerant internal energy which is liberated in the form of flash gas, and a controlled reduction to the evaporator temperature level so useful cooling can take place on a product or process.

The expansion device, either by initial sizing in the case of a capillary tube, or feedback system such as a bulb on a thermostatic expansion valve, also provides for a slight controlled superheating of the vaporized refrigerant at the cooling heat exchanger thus increasing the enthalpy to H2 on the cycle. This increase from H1 to H2 provides a slight additional amount of useful cooling at the evaporator, and most importantly serves to protect the compressor by insuring that only superheated vapor enters; no liquid enters which could damage a compressor. Expansion devices typically require the pressure differential across them (P1-P2) to remain within a relatively consistent range so that they can function properly. At too low of a differential, there would not be enough flash gas formed to effectively control flow through the device.

The compressor adds work to the system and increases the pressure level back to P1 and increases the enthalpy to H3. At the higher pressure-temperature-enthalpy level of H3, heat can be rejected to the high level heat sink (condenser) and the refrigerant is condensed to a liquid at H4 to complete the cycle.

3. Objects and Advantages

It is a principal object and advantage of the present invention to provide a refrigerant control that is independent of the refrigeration cycle system.

It is another object and advantage of the present invention to provide control of a refrigeration cycle that permits the refrigeration effect to improve.

It is another object and advantage of the present invention to provide control of a refrigeration cycle that requires the compressor to work less.

It is another object and advantage of the present invention to provide control of a refrigeration cycle that maintains a low compressor energy input at all times, but still provides regulated flow control to the evaporator.

Other objects and advantages of the present invention will in part be obvious and in part appear hereinafter.

### SUMMARY OF THE INVENTION

In accordance with the foregoing objects and advantages, a new valve is used in place of a typical pressure reducing expansion valve or capillary tube. The valve will regulate saturated liquid flow at H4 enroute to the evaporator by introducing a controlled ultrasonic crystal pulse within the valve. The controlled excitation will form pressure waves and vapor pockets that result in vapor sonic velocity at the valve which is variable. Similar to TXV/capillary flow devices that form flash gas and subsequent sonic velocity flow restriction/control, so too will the valve cause sonic flow regulation. The primary difference is that the valve is regulated by a mechanism which is external of the cycle, which also permits it to be regulated independently. One benefit of the valve, therefore, is the ability to regulate flows at cycle conditions that are substantially “off” of original design.

For example, an air-conditioning system originally designed for an air-cooled condenser at 110F ambient air inlet temperature and perhaps a refrigerant condensing temperature of 125F and an evaporator temperature of 45F, utilizes controls like fan cycling at the condenser, pressure control valves, liquid feedback to condenser, etc. to keep this relationship intact as best as possible even during low ambient conditions. If ambient conditions are perhaps 75F, the controls force the system to remain at an artificially higher level than are actually available to be attained, all in the interest of keeping the TXV or capillary system functioning properly.

With the valve in accordance with the present invention, the system head pressure would be allowed to drop, for example to P3 and H5. This causes the refrigeration effect to improve; ie: H1-H5 would be greater than H1-H4 on the Cycle diagram of FIG. 2. The compressor work would be substantially reduced; ie: H7-H2 would be less than H3-H2. Ultrasonic crystal excitation would be increased at the coincident time that the head pressure across the compressor could be reduced, thus maintaining the lowest compressor energy input at all times, but still providing regulated flow control to the evaporator. A pressure and temperature sensor would be used to further control the valve to insure only saturated vapor enters the compressor (and not liquid.)

A variable speed control compressor would be used, or cylinder unloader control on larger compressors, or current digital scroll compressor technology to match the reduced pumping capacity of vapor to attain H7-H2 vs H3-H2.

In accordance with an embodiment of the invention, a valve assembly for use in a refrigerant control system is provided. The valve assembly generally comprises (i) a capillary tube having a first end and a second end; (ii) a wave propagating casing encapsulating a portion of the capillary tube between the first and second ends; (iii) a resonant piezo assembly operable at a predetermined frequency attached to the wave propagating casing; and (iv) a conductive wire for transmitting electrical energy to the resonant piezo assembly, whereby the resonant piezo assembly induces vibration in the wave propagating casing and the capillary tube.

In an aspect of the invention, the wave propagating casing comprises first and second plates bonded to one another. In another aspect, the first and second plates include first and second pathways cored therefrom, the first and second pathways being aligned with one another when the first and second plates are bonded to one another, and the portion of the capillary tube encapsulated by the wave propagating casing is positioned within said first and second pathways.

In another aspect of the invention, a refrigerant control system is provided. The system generally comprises (i) a refrigerant compressor having first and second sides; (ii) a condenser coil having a first side in uninterrupted fluid communication with the first side of the refrigerant compressor, and a second side; (iii) a valve assembly, comprising: (a) a capillary tube having a first end in fluid communication with the second side of said condenser coil, and a second end; (b) a wave propagating casing encapsulating a portion of the capillary tube between the first and second ends; (c) a resonant piezo assembly operable at a predetermined frequency attached to the wave propagating casing; and (d) a conductive wire for transmitting electrical energy to the resonant piezo assembly, whereby the resonant piezo assembly induces vibration in the wave propagating casing and the capillary tube; and (iv) an evaporator coil having a first side in uninterrupted fluid communication with the second end of the capillary tube, and a second side in uninterrupted fluid communication with the second end of said refrigerant compressor.

In another aspect of the invention, a method for controlling refrigerant flow in a refrigerant system comprising a refrigerant compressor, a condenser coil, a valve assembly comprising a capillary tube, a wave propagating casing through which the capillary tube passes, a resonant piezo assembly, and a conductive wire for transmitting electrical energy to the resonant piezo assembly, and an evaporator coil, wherein the method generally comprises the steps of: (i) condensing high pressure, high temperature gas to liquid refrigerant in the condenser coil; (ii) passing the liquid refrigerant through the capillary tube; (iii) providing electrical energy to the conductive wire to induce the resonant piezo assembly to resonate and produce vibration in the wave propagating casing; (iv) flashing the liquid refrigerant to flash gas prior to its entering the evaporator coil; and (v) evaporating the flash gas prior to its entering the condenser.

### BRIEF DESCRIPTION OF THE DRAWINGS

The present invention will be more fully understood and appreciated by reading the following Detailed Description in conjunction with the accompanying drawings, in which:

FIGS. 1a and 1b are a pressure-enthalpy diagram and corresponding schematic representation of a classical prior art compression refrigeration cycle, respectively.

FIGS. 2a and 2b are a pressure enthalpy diagram and corresponding schematic representation of a compression refrigeration cycle in accordance with the present invention, respectively.

FIG. 3 is a perspective view of a system independent valve assembly in accordance with an embodiment of the present invention.

FIG. 4 is a cross-sectional view taken along section line 4-4 of FIG. 3.

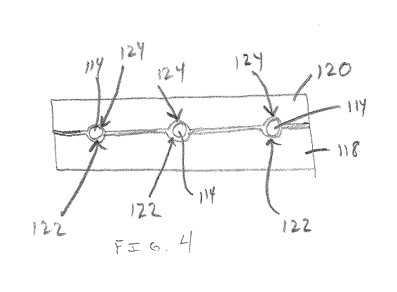

### DETAILED DESCRIPTION

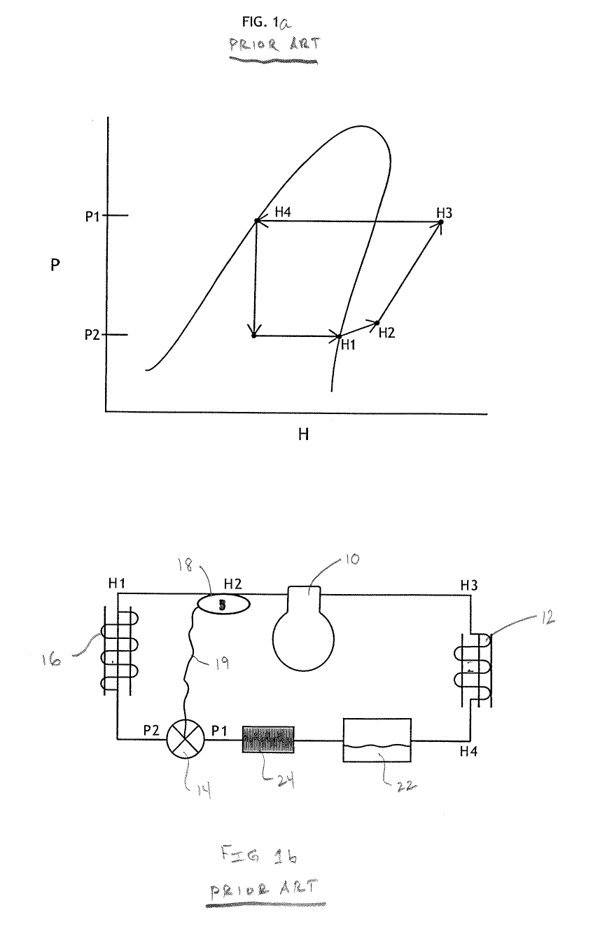

Referring to the drawings, wherein like reference numerals refer to like parts throughout, there is seen in FIG. 1a diagram of a classical prior art compression refrigeration cycle. Refrigerant compressor 10 creates high temperature high pressure gas at H3 which is then delivered to the condenser coil 12 whereby the high pressure high temperature gas condenses to a saturated liquid at H4 at high temperature and high pressure. The high temperature and high pressure sub-cools from saturation temperature and pressure at the control valve 14 which is in fluid communication with the liquid refrigerant. The control valve 14 reduces the liquid pressure according to a pre-established degree in the evaporator coil 16 as dictated by control sensor 18 which senses the temperature in the evaporator coil 16 increasing the temperature from H1 to H2 whereby this gas returns to the compressor 10 to complete the cycle. In addition, a temperature feedback loop 20 provides the temperature reading from sensor 18 to valve 14 to better regulate the valve's operation. Furthermore, a filter dryer 22 and sight glass 24 can be inserted in line between condenser coil 12 and valve 16 to further assist in regulation and control of the refrigeration cycle.

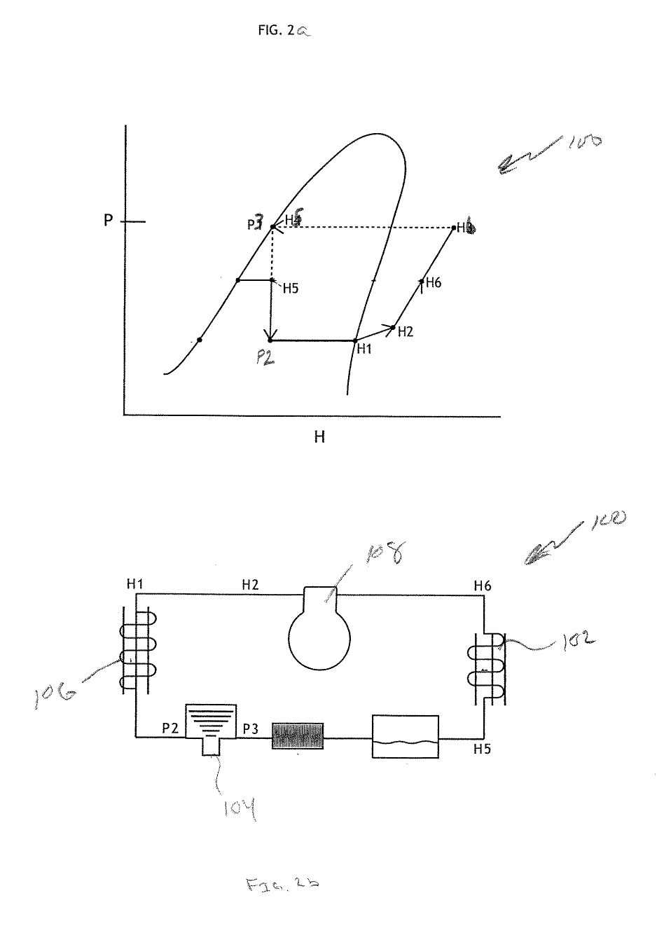

FIG. 2 illustrates the pressure enthalpy process of the compression refrigeration cycle 100 in accordance with the present method. High temperature high pressure gas at H6 is condensed in the condenser coil 102 at H5 where it enters the present method valve 104, which is not in fluid communication with the liquid refrigerant, at P3 at which point the liquid refrigerant flashes to P2 where it enters the evaporator 106. The flash gas evaporates absorbing heat and moving through H1 to H2. The compressor 108 then increases the pressure and temperature of the gas back to H6 to complete the cycle.

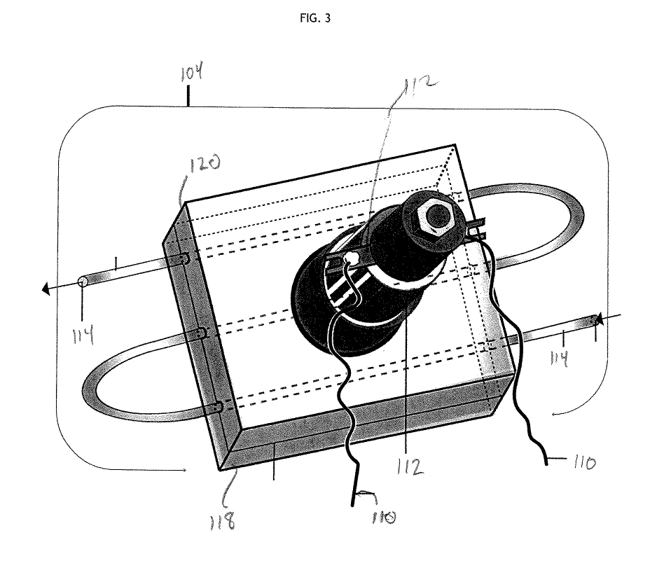

FIG. 3 illustrates the operation of the present method valve 104. An electrical signal is transmitted through conductive wire 110 to resonant crystal 112 (e.g., a resonant piezo assembly) whose deformations cause sonic waves to energize liquid refrigerant in capillary tube 114 thereby restricting refrigerant flow. Liquid line 114 is coupled to sonic waves by virtue of being embedded in resonant block 116 (e.g., a wave propagating casing) which is not in fluid communication with liquid refrigerant.

Resonant block 116 comprises two blocks 118/120 that are bonded together with epoxy or other bonding agent. Each block 118/120 includes a semi-circular core 122/124 removed therefrom. When bonded together the semi-circular cores are aligned forming a circular core having a diameter equal to the outside diameter of capillary tube 114 which is seated therein. The circular core extends along a serpentine pathway to permit sufficient length of capillary tube 114 to extend therethrough and become agitated by the vibrations formed by the sonic waves for purposes of performing the intended function.

What is claimed is:

1) A valve assembly for use in a refrigerant control system, comprising
a) a capillary tube having a first end and a second end;
b) a wave propagating casing encapsulating a portion of said capillary tube between said first and second ends;
c) a resonant piezo assembly operable at a predetermined frequency attached to said wave propagating casing; and
d) a conductive wire for transmitting electrical energy to said resonant piezo assembly, whereby said resonant piezo assembly induces vibration in said wave propagating casing and said capillary tube.

2) The valve assembly according to claim 1, wherein said wave propagating casing comprises first and second plates bonded to one another.

3) The valve assembly according to claim 2, wherein said first and second plates include first and second pathways cored therefrom, said first and second pathways being aligned with one another when said first and second plates are bonded to one another, and said portion of said capillary tube encapsulated by said wave propagating casing is positioned within said first and second pathways.

4) The valve assembly according to claim 3, wherein said first and second pathways are serpentine in shape.

5) A refrigerant control system, comprising:
a) a refrigerant compressor having first and second sides;
b) a condenser coil having a first side in uninterrupted fluid communication with said first side of said refrigerant compressor, and a second side;
c) a valve assembly, comprising:
i) a capillary tube having a first end in fluid communication with said second side of said condenser coil, and a second end;
ii) a wave propagating casing encapsulating a portion of said capillary tube between said first and second ends;
iii) a resonant piezo assembly operable at a predetermined frequency attached to said wave propagating casing; and
iv) a conductive wire for transmitting electrical energy to said resonant piezo assembly, whereby said resonant piezo assembly induces vibration in said wave propagating casing and said capillary tube; and
d) an evaporator coil having a first side in uninterrupted fluid communication with said second end of said capillary tube, and a second side in uninterrupted fluid communication with said second end of said refrigerant compressor.

6) The refrigerant control system according to claim 5, wherein said wave propagating casing comprises first and second plates bonded to one another.

7) The refrigerant control system according to claim 6, wherein said first and second plates include first and second pathways cored therefrom, said first and second pathways being aligned with one another when said first and second plates are bonded to one another, and said portion of said capillary tube encapsulated by said wave propagating casing is positioned within said first and second pathways.

8) The refrigerant control system according to claim 7, wherein said first and second pathways are serpentine in shape.

9) A method for controlling refrigerant flow in a refrigerant system comprising a refrigerant compressor, a condenser coil, a valve assembly comprising a capillary tube, a wave propagating casing through which the capillary tube passes, a resonant piezo assembly, and a conductive wire for transmitting electrical energy to the resonant piezo assembly, and an evaporator coil, said method comprising the steps of:
a) condensing high pressure, high temperature gas to liquid refrigerant in the condenser coil;
b) passing the liquid refrigerant through the capillary tube;
c) providing electrical energy to the conductive wire to induce the resonant piezo assembly to resonate and produce vibration in the wave propagating casing;
d) flashing the liquid refrigerant to flash gas prior to its entering the evaporator coil; and
e) evaporating the flash gas prior to its entering the condenser.
